(19) United States
(12) Patent Application Publication
(10) Pub. No.: US 2007/0080826 A1
(43) Pub. Date: Apr. 12, 2007

(54) PLUGGABLE DIGITAL VIDEO RECORDING DEVICE FOR CAR USE

(76) Inventor: Ching-Shan Chang, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/309,102

(22) Filed: Jun. 23, 2006

(30) Foreign Application Priority Data
Oct. 6, 2005 (TW) 94134926

(51) Int. Cl. G08G 1/054

(52) U.S. Cl. 340/937

(57) ABSTRACT

A pluggable digital video recording device for car use is provided, including a casing, a control panel, a locker and a main unit. The casing is accommodated in an external box, and the control panel is disposed on the casing and aligned with the front edge of the external box. In addition, the locker is disposed on the control panel for locking the casing onto the external box. Moreover, the main unit has a plurality of data storage media in the casing. If the video recording device needs to be removed from the car for use, it is only necessary to unlock the locker and connect the device to the computer host by a data transmission line, and then power is supplied to the video recording device to directly play the video and audio information.

CROSS-REFERENCE TO RELATED APPLICATION

This application claims the priority benefit of Taiwan application serial no. 94134926, filed on Oct. 6, 2005. All disclosure of the Taiwan application is incorporated herein by reference.

### BACKGROUND OF THE INVENTION

1. Field of Invention

The present invention relates to a portable storage device. More particularly, the present invention relates to a pluggable digital video recording device for car use.

2. Description of Related Art

The main function of a digital video recorder (DVR in short) is to replace the conventional analog video recorder. The data is digitalized through the digital video recording operation, so that it can be saved for a long time and thus can be searched in the database. Also, the cost and space of a storage medium may be saved. The digital video recorder is a high-tech product of the modern security monitoring system.

Generally, a digital video recorder is equipped with a hard disk driver and a video capture card. The data captured by the external sensing elements can be stored in a hard disk with large storage capacity. Usually, when a 30 GB hard disk is recorded in a dynamic image format, it may be used for about 400˜720 hours. A large amount of image data may also be copied from the hard disks into other storage media (such as optical disks) for filing or management. As the compression technology employed by digital video recording becomes mature and the compression rate is high, it is suitable for long-time video monitoring. In case of long-time continuous recording, the user only needs to buy a hard disk with enough compression space. Thus, security can be guaranteed at home or on the road.

However, a typical digital video recorder for car use is screwed in the car, and the main body thereof is locked and enclosed in the housing and cannot be removed, which is very inconvenient. In addition, as the digital video recorder for car use is too bulky, and it is not as light, thin, short and small as a general portable electronic device, it is not very portable and occupies too much space.

### SUMMARY OF THE INVENTION

Accordingly, the present invention is directed to provide a pluggable digital video recording device for car use, which can be removed from the car and can be used as a portable data storage medium.

The present invention provides a pluggable digital video recording device for car use, which is suitable to be used in a security monitoring system. The security monitoring system comprises a plurality of image sensors, a satellite positioning receiver, a loudspeaker and a display for car use. This pluggable digital video recording device for car use comprises a casing, a control panel, a locker and a main unit. The casing can be accommodated into an external box in the car, and the control panel is disposed on the casing and aligned to the front edge of the external box. In addition, the locker is disposed on the control panel for locking the casing onto the external box. Moreover, the main unit has a plurality of data storage media in the casing. The main unit records dynamic images and voices digitally, and stores the data detected by the security monitoring system into these data storage media through real-time recording.

According to an embodiment of this invention, the above-mentioned main unit further comprises a transmission interface. When the pluggable digital video recording device for car use is unlocked from the external box and removed, it can be connected to a computer host via this transmission interface. The transmission interface is, for example, a universal serial bus (USB) or an IEEE1394 transmission interface.

According to an embodiment of this invention, the above-mentioned control panel comprises a plurality of control keys for performing record, pause, play, and stop functions, etc.

According to an embodiment of this invention, the above-mentioned data storage media are, for example, hard disks.

As the present invention adopts a pluggable main body, one can directly insert it into the external box, align the control panel thereof to the front edge of the external box, and then lock the locker without a complicated locking mechanism. If the main body must be removed from the car, only the locker needs to be unlocked and removed from the main body, and the main body can be connected to the computer host by a high-speed data transmission line, and then power is supplied to the video recording device to directly play the video and audio information. Thus, the present invention is very convenient and portable.

In order to the make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 depicts a schematic view of a digital video recording device according to the present invention used in a security monitoring system.

FIG. 2 depicts an assembled schematic view of a pluggable digital video recording device for car use according to the present invention.

FIG. 3 depicts a schematic view after the digital video recording device of FIG. 2 is removed.

FIG. 4 depicts a schematic view of the interior of the external box of FIG. 3.

### DESCRIPTION OF EMBODIMENTS

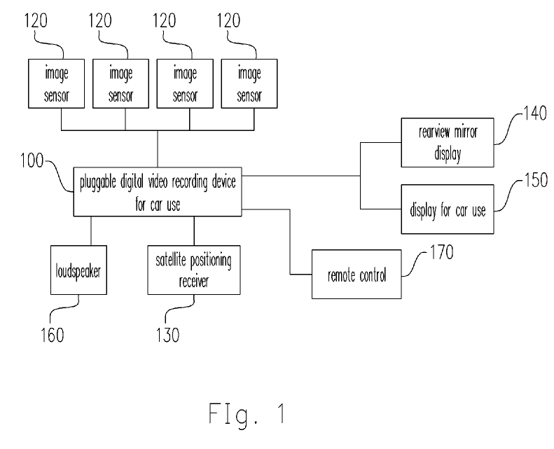

Referring to FIG. 1, a schematic view of a digital video recording device according to the present invention used in a security monitoring system is shown. In this embodiment, the detailed illustration is particularly related to a digital video recording device 100 used by a security monitoring system in a car. The main body of this digital video recording device 100 may be connected to various external monitoring apparatuses, comprising mini image sensors 120, a satellite positioning receiver 130, a rearview mirror display 140, a display 150 for car use, a loudspeaker 160, a remote control 170, etc. The mini image sensors 120 are, for example, CMOS image sensors or CCD image sensors with high resolution, which can be coupled in the front and back sides of a car, in order to dynamically capture the real-time images and transmit the data back to the digital video recording device 100, so as to store the data and record the time. In addition, the satellite positioning receiver 130 may get the traffic information at any time, and transmit the data back to the digital video recording device 100 to inform the driver of the latest traffic information. The rearview mirror display 140 and the display 150 for car use display the data received by the image sensors 120 and the satellite positioning receiver 130, and send out warning sounds or road reports via the loudspeaker 160, so that the driver can watch the latest dynamic information.

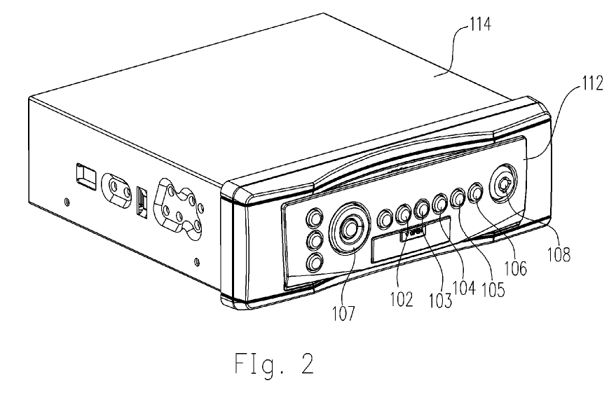

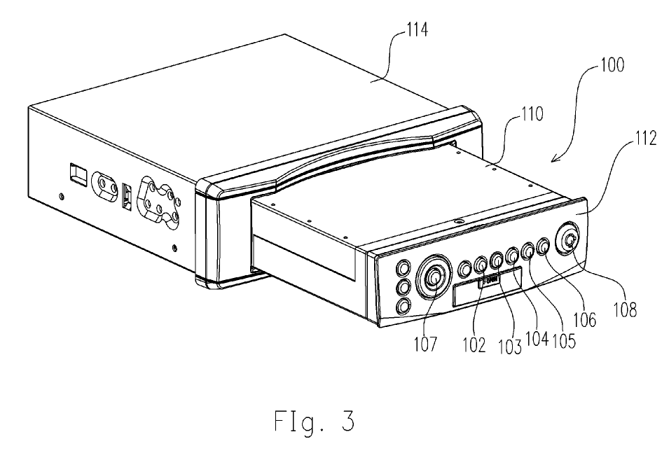

Referring to FIGS .2 and 3. FIG. 2 depicts an assembled schematic view of a pluggable digital video recording device for car use according to the present invention, and FIG. 3 depicts a schematic view after the digital video recording device of FIG. 2 is removed. This digital video recording device 100 has a casing 110 and a control panel 112. A main unit can be mounted in the casing 110. The main unit has a plurality of data storage media for storing dynamic images (not shown in FIGS. 2 and 3). The casing 110 is accommodated into an external box 114 in the car, and the control panel 112 is coupled on the front edge of the casing 110 for inputting the video recording signal or playing signal to the main unit. In this embodiment, the control panel 112 comprises a plurality of control keys 102˜106 for performing the record, pause, play, and stop functions, etc. Certainly, a common control key 107, such as a fast-forward/backward key or a searching key, or the like, may also appear on the control panel 112.

In addition, a locker 108 is disposed on the control panel 112. When a user inserts the digital video recording device 100 into the external box 114, and aligns the control panel 112 with the front edge of the external box 114, a key (not shown) is inserted to lock into the locker 108, therefore the casing 110 is fixed in the external box 114 and can not be removed. If the digital video recording device 100 is required to be removed from the external box 114, only the locker 108 needs to be unlocked with the key, without removing the screws or other locking mechanisms. Thus, the digital video recording device of the invention can be conveniently installed or removed.

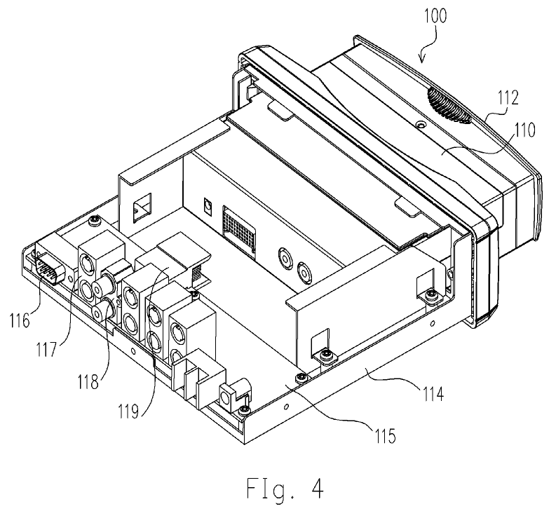

Referring to FIG. 4, a schematic view of the interior of the external box of FIG. 3 is shown. In this embodiment, various signal connectors 116˜119 may be disposed on a substrate 115 of the external box 114 to connect different kinds of signal terminals, such as an AV terminal, a RS-232 terminal or other digital signal terminals. In addition, the digital video recording device 100 further has a transmission interface (not shown), for example, a high-speed transmission interface such as USB2.0 or IEEE1394, or the like, to serve as the output terminal of image signals. When the digital video recording device 100 is removed from the car, it can be connected to a computer host (not shown) via a high-speed signal transmission line and then the video and audio information can be directly played. Alternatively, the software built in a computer may be used to search the video at a certain time. Also, the user can transmit the video images via a network or print the static video images, such as various multimedia files such as MPEG-4, JPEG or M-JPEG, or the like. In addition, a large amount of image data in the digital video recording device 100 may also be copied from the data storage media (such as hard disks) into other storage media (such as optical disks) for filing or management. Thus, the digital video recording device 100 is very suitable for long-time video monitoring.

In summary, the main body of the pluggable digital video recording device for car use according to the present invention records dynamic images and voices digitally, and stores the data detected by the security monitoring system into the data storage media through real-time recording. Also, the volume of the main body is reduced, so the device occupies less space when it is removed and thus can be used as a portable data storage medium. Particularly, since the casing of the pluggable digital video recording device for car use is locked onto the external box only by a locker, the device can be conveniently installed and removed and thus has high practicability.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A pluggable digital video recording device for car use suitable for a security monitoring system, the safety monitoring system comprising a plurality of image sensors, a satellite positioning receiver, a loudspeaker and a display used in a car, the pluggable digital video recording device for car use comprising:
a casing, accommodated in an external box in the car;
a control panel, disposed on the casing and aligned with a front edge of the external box;
a locker, disposed on the control panel for locking the casing onto the external box; and
a main unit, having a plurality of data storage media in the casing, the main unit recording dynamic images and voices digitally, and storing the data detected by the safety monitoring system into the data storage media through real-time recording.

2. The pluggable digital video recording device for car use as claimed in claim 1, wherein the main unit further comprises a transmission interface connecting the pluggable digital video recording device for car use to a computer host when the pluggable digital video recording device for car use is unlocked from the external box and removed.

3. The pluggable digital video recording device for car use as claimed in claim 1, wherein the transmission interface is a universal serial bus (USB) transmission interface or an IEEE1394 transmission interface.

4. The pluggable digital video recording device for car use as claimed in claim 1, wherein the control panel comprises a plurality of control keys for performing record, pause, play, and stop functions.

5. The pluggable digital video recording device for car use as claimed in claim 1, wherein the data storage media comprise hard disks.
